(19) United States
(12) Patent Application Publication
(10) Pub. No.: US 2005/0219455 A1
(43) Pub. Date: Oct. 6, 2005

(54) Liquid crystal display panel and method for manufacturing the same

(75) Inventors: Tsau Hua Hsieh, Miao-Li (TW); Jia-Pang Pang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/096,891

(22) Filed: Mar. 31, 2005

(30) Foreign Application Priority Data
Apr. 2, 2004 (TW) 93109175

(51) Int. Cl. G02F 1/1339

(52) U.S. Cl. 349/153

(57) ABSTRACT

A liquid crystal display panel (3) includes: a first substrate (300) and a second substrate (350) opposite to each other, the second substrate defining a display area (3502) and a peripheral area (3501); a liquid crystal layer containing a plurality of liquid crystal molecules (303) disposed between the first and second substrates; a sealant (310) associated with the peripheral area for supporting and adhering the first and second substrates together; and an isolating member (360) isolating the sealant from the liquid crystal layer. The isolating member of the liquid crystal display panel is located between the liquid crystal molecules and the sealant. This prevents the liquid crystal from reacting with uncured sealant, and thus improves the performance of the liquid crystal display panel.

### 1. FIELD OF THE INVENTION

The present invention relates to liquid crystal display panels and methods for their manufacture.

### 2. GENERAL BACKGROUND

An LCD device has the advantages of portability, low power consumption, and low radiation, and has been widely used in various portable information products such as notebooks, personal digital assistants (PDAs), video cameras and the like. Furthermore, the LCD device is considered by many to have the potential to completely replace CRT (cathode ray tube) monitors and televisions.

The liquid crystal display panel is an important element of the liquid crystal display, and includes two opposite substrates and a liquid crystal layer between the substrates. There are several ways of filling liquid crystal material; for example, the vacuum filling method and the one-drop-fill (ODF) method. In assembly of the panel using the vacuum filling method, the substrates are aligned with each other and joined such that they are separated by a gap on the order of a few microns. The structure is placed in a vacuum chamber for removal of air. The structure is then placed in a dish of liquid crystal material, which is forced into the evacuated panel space by backfilling of the vacuum chamber with nitrogen gas. However, the vacuum filling method is exceedingly slow, and wastes liquid crystal material. Thus the faster ODF method was developed. A version of the ODF method is disclosed in U.S. Pat. No. 5,263,888, issued on Nov. 23, 1993. Using the ODF method can save much time, and generally requires less liquid crystal material.

FIG. 9 shows a bottom plan view relating to a second substrate 150 of a conventional liquid crystal display panel 1, and FIG. 10 shows a schematic, side cross-sectional view of the liquid crystal display panel 1. Referring to FIGS. 9 and 10, the liquid crystal display panel 1 includes a first substrate 100, the second substrate 150, and a liquid crystal layer 103 comprising a plurality of liquid crystal molecules. The liquid crystal layer 103 is sandwiched between the first and second substrates 100, 150.

The first substrate 100 includes a plurality of data lines (not shown) and gate lines (not shown). The data lines are perpendicular to the gate lines. A plurality of TFTs (Thin Film Transistors) is formed at crossings of the data and gate lines. An alignment film 101 is formed on an inner side of the first substrate 100.

The second substrate 150 defines a central display area 1502 and a peripheral area 1501. A sealant 110 in the form of a continuous line is located at the peripheral area 1501. The sealant 110 is made of a light hardening material; in particular, the sealant 110 is hardened by UV radiation. The first substrate 100 and the second substrate 150 are attached together by the sealant 110. The liquid crystal layer 103 is separated from air by the sealant 110. A black matrix 130 in the form of a continuous thick line is located on an inner side of the second substrate 150, straddling a region where the display area 1502 adjoins the peripheral area 1501 in order to avoid light shielding phenomena. An alignment film 151 is deposited on the inner side of the second substrate 150, and covers the black matrix 130.

The liquid crystal display panel 1 is manufactured by the ODF process. The process includes the steps of: providing the first substrate 100 and the second substrate 150; forming the sealant 110 and the black matrix 130 on the second substrate 150; dropping liquid crystal material on the display area 1502 of the second substrate 150, the liquid crystal material comprising a mixture of liquid crystal molecules and spacers; attaching the first substrate 100 and the second substrate 150 together in a vacuum chamber; and curing the sealant 110 by applying UV (ultraviolet) light. When the sealant 110 has hardened, formation of the liquid crystal display panel 1 is completed.

However, the display area 1502 adjoins the sealant 110 of the liquid crystal display panel 1. In the process of manufacturing the liquid crystal display panel 1 using the ODF method, thermal setting epoxy cannot be used. Instead, UV-curable epoxy or another kind of epoxy which cures near room temperature must be used. As will be understood, the uncured sealant 110 must necessarily come in contact with the liquid crystal molecules because the sealant 110 forms the peripheral boundary wall for the liquid crystal material. There is mounting evidence that uncured sealant 110 tends to react with the liquid crystal molecules, and degrade the performance of the liquid crystal molecules as liquid crystal material. This deleterious effect is especially likely in those regions of the display panel where there is incomplete curing of the UV epoxy. Incomplete curing occurs where UV light is unable to reach all portions of the UV epoxy, due to shadows cast by the thin film circuitry that extends out to peripheral areas of the substrates 100, 150.

What is needed, therefore, is a liquid crystal display panel which overcomes the above-described deficiencies.

What is also needed is a method for manufacturing a liquid crystal display panel which overcomes the above-described deficiencies.

### SUMMARY

One embodiment provides a liquid crystal display panel including a first substrate and a second substrate opposite to each other, the second substrate defining a display area and a peripheral area; a liquid crystal layer containing a plurality of liquid crystal molecules disposed between the first and second substrates; a sealant associated with the peripheral area for supporting and adhering the first and second substrates together; and an isolating member isolating the sealant from the liquid crystal layer.

In another embodiment, a method for manufacturing the liquid crystal display panel includes the following steps: providing a first substrate and a second substrate, the second substrate defining a display area and a peripheral area; forming a sealant associated with the peripheral area of the second substrate; forming an isolating member associated with the peripheral area of the second substrate, the isolating member being associated with the sealant; dropping liquid crystal material on the first substrate; attaching and integrating the first substrate and the second substrate together in a vacuum chamber; and hardening the sealant using ultraviolet light.

Compared with a conventional liquid crystal display panel, the first above-described embodiment has the following advantage. The liquid crystal display panel of a preferred embodiment includes the isolating member disposed between the liquid crystal layer and the sealant. This prevents the liquid crystal molecules from reacting with the uncured sealant, and improves the performance of the liquid crystal display.

Other advantages and novel features will become more apparent from the following detailed description when taken in conjunction with the accompanying drawings, in which:

### BRIEF DESCRIPTION OF THE DRAWINGS

FIG. 1 is a schematic, bottom plan view of one substrate and associated components of a liquid crystal display panel in accordance with a first preferred embodiment of the present invention;

FIG. 2 is a schematic, cross-sectional view of the liquid crystal display panel in accordance with the first preferred embodiment;

FIGS. 3 and 4 are schematic, cross-sectional views of sequential stages in a method for manufacturing the liquid crystal display panel of the first preferred embodiment;

FIG. 5 is a schematic, bottom plan view of one substrate and associated components of a liquid crystal display panel in accordance with a second preferred embodiment of the present invention;

FIG. 6 is a schematic, cross-sectional view of the liquid crystal display panel in accordance with the second preferred embodiment;

FIGS. 7 and 8 are schematic, cross-sectional views of sequential stages in a method for manufacturing the liquid crystal display panel of the second preferred embodiment;

FIG. 9 is a schematic, bottom plan view of one substrate and associated components of a conventional liquid crystal display panel; and

FIG. 10 is a schematic, cross-sectional view of the conventional liquid crystal display panel referred to in the above paragraph.

### DETAILED DESCRIPTION OF THE PREFERRED EMBODIMENTS

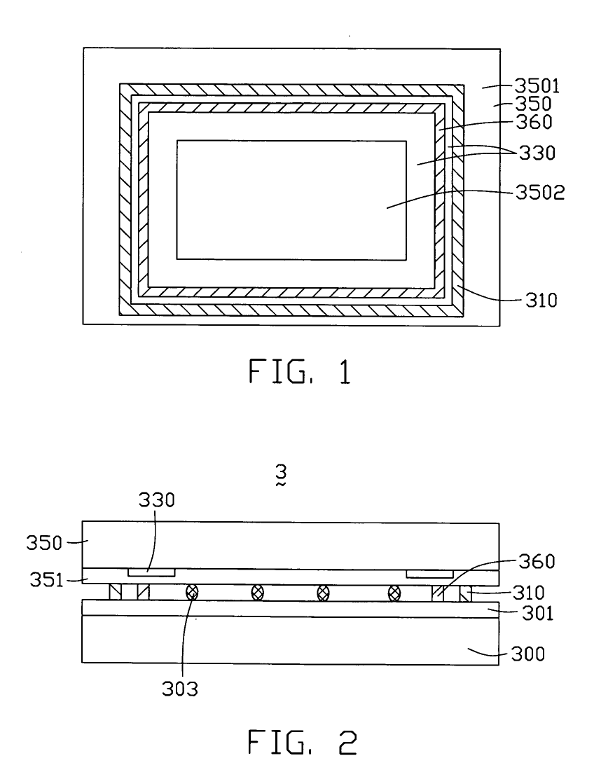

FIG. 1 shows a bottom plan view relating to a second substrate 350 of a liquid crystal display panel 3 in accordance with a first preferred embodiment of the present invention. FIG. 2 shows a cross-sectional view of the liquid crystal display panel 3. Referring to FIGS. 1 and 2, the liquid crystal display panel 3 includes a first substrate 300, the second substrate 350 and a liquid crystal layer (not shown in full) comprising a plurality of liquid crystal molecules 303. The liquid crystal layer is sandwiched between the first and second substrates 300, 350.

An alignment film 301 is formed on an inner side of the first substrate 300. The first substrate 300 includes a plurality of data lines (not shown) and gate lines (not shown). The data lines are perpendicular to the gate lines. A plurality of TFTs (Thin Film Transistors) is formed at crossings of the data and gate lines. A plurality of pixel electrodes (not shown) is deposited on the first substrate 300, the pixel electrodes being connected with drain electrodes of the TFTs.

An alignment film 351 is formed on an inner side of the second substrate 350. The second substrate 350 includes a color filter (not shown) and a common electrode (not shown). The common electrode and the pixel electrode can form an electric field to drive the liquid crystal molecules 303, so that a display of the liquid crystal display panel 3 is obtained.

The second substrate 350 defines a central display area 3502 and a peripheral area 3501. A sealant 310 in the form of a continuous line is located at the peripheral area 3501. The sealant 310 is made of a light hardening material; in particular, the sealant 310 is hardened by UV radiation. The first substrate 300 and the second substrate 350 are attached together by the sealant 310. A blocker 360 in the form of a continuous line is located around a periphery of the display area 3502. The liquid crystal molecules 303 and the sealant 310 are separated by the blocker 360, in order to avoid reaction between the liquid crystal molecules 303 and the uncured sealant 310. The blocker 360 is made of elastic material, such as Polymethyl Methacrylate (PMMA), Natural Rubber (NR), Styrene Butadiene Rubber (SBR), Isobutylene-Isoprene Rubber (IIR), Nitrile-Butadiene Rubber (NBR), or Ethylene-Propylene-Diene Monomer (EPDM). The blocker 360 and the sealant 310 are spaced apart by a substantially uniform gap. A black matrix 330 in the form of a continuous thick line is located on the inside of the second substrate 350, straddling a region where the display area 3502 adjoins the peripheral area 3501 in order to avoid light shielding phenomena. The black matrix 330 is made from chromium (Cr) and is opaque. The black matrix 330 covers the blocker 360 and is spaced a horizontal distance from the sealant 310, so that light can pass through the second substrate 350 and harden the sealant 310.

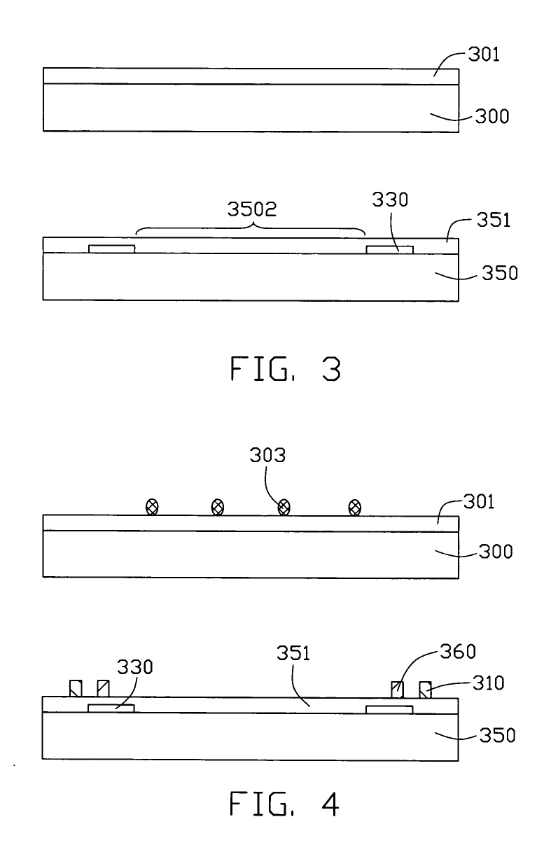

FIGS. 3 and 4 are schematic, cross-sectional views of sequential stages in a method for manufacturing the liquid crystal display panel 3.

Referring to FIG. 3, the first substrate 300 and the second substrate 350 are provided. The second substrate 350 includes the peripheral area 3501 and the display area 3502. The black matrix 330 is formed on a region straddling the peripheral area 3501 and the display area 3502. The alignment film 351 is formed on the second substrate 350, and covers the black matrix 330. The alignment film 301 is formed on the first substrate 300. A plurality of spacers (not shown) is deposited on the alignment film 301.

Referring to FIG. 4, liquid crystal molecules 303 are dropped on the alignment film 301. The sealant 310 is formed on the alignment film 351 in the peripheral area 3501. The sealant 310 and the black matrix 330 are spaced apart by a horizontal gap, so that light can pass through the second substrate 350 and harden the sealant 310. The blocker 360 is formed on the alignment film 351. The blocker 360 is deposited between the sealant 310 and the display area 3502, so that it can separated the sealant 310 and the liquid crystal molecules 303.

Referring to FIG. 2, the second substrate 350 is turned over and positioned on the first substrate 300. Assembly of the first substrate 300 and the second substrate 350 is performed in a vacuum chamber (not shown). After that, the combined substrates 300, 350 are taken out from the vacuum chamber. The substrates 300, 350 are securely held together by reason of atmospheric pressure exerting on the combination. Then the sealant 310 is hardened by U radiation, so that the substrates 300, 350 are firmly attached together. The liquid crystal display panel 3 is thus formed.

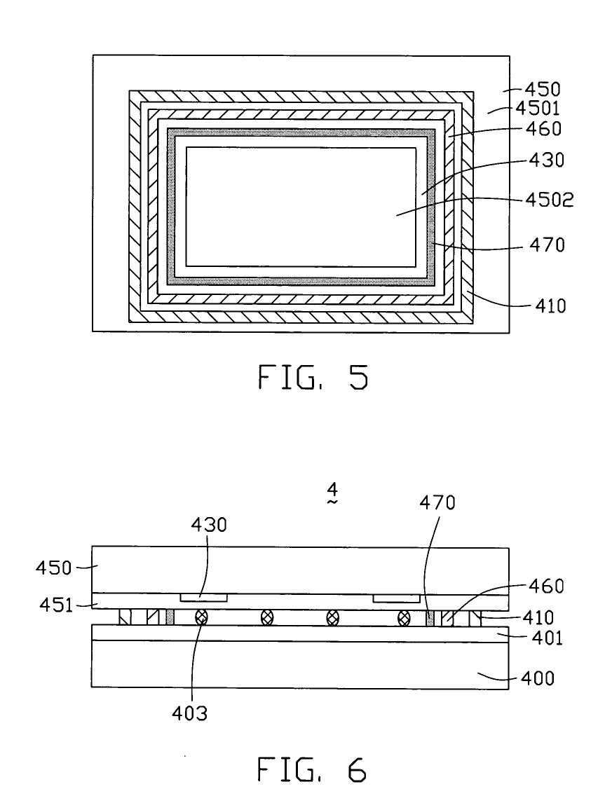

FIG. 5 shows a bottom plan view relating to a second substrate 450 of a liquid crystal display panel 4 in accordance with a second preferred embodiment of the present invention. FIG. 6 shows a cross-sectional view of the liquid crystal display panel 4. Referring to FIGS. 5 and 6, the liquid crystal display panel 4 includes a first substrate 400 and the second substrate 450. The second substrate 450 defines a central display area 4502 and a peripheral area 4501. A sealant 410 and a blocker 460 are formed on the peripheral area 4501, and are spaced apart by a substantially uniform gap. A black matrix 430 is formed on a region straddling the display area 4502 and the peripheral area 4501. An optical spacer 470 in the form of continuous line is formed on the peripheral area 4501. The optical spacer 470 is spaced apart from an outside extremity of the black matrix 430 by a horizontal gap. The optical spacer 470 helps the liquid crystal display panel 4 have a uniform thickness.

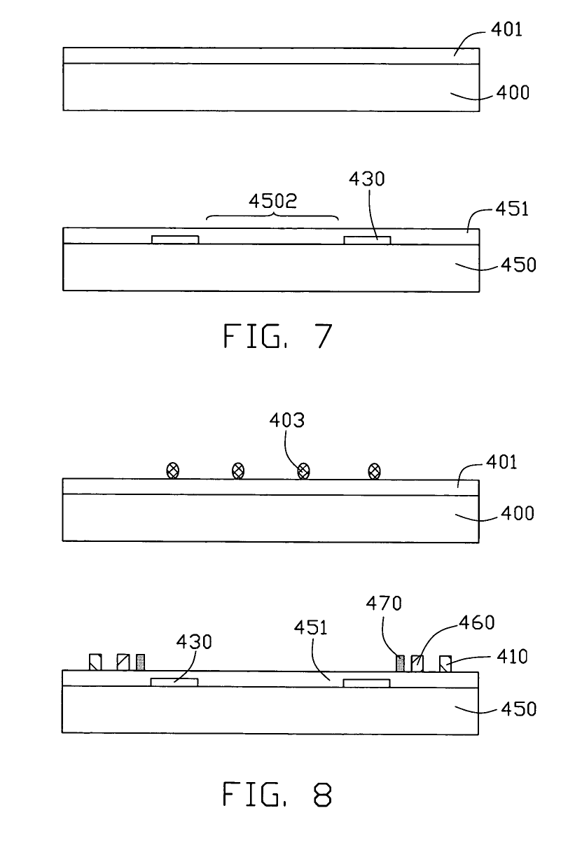

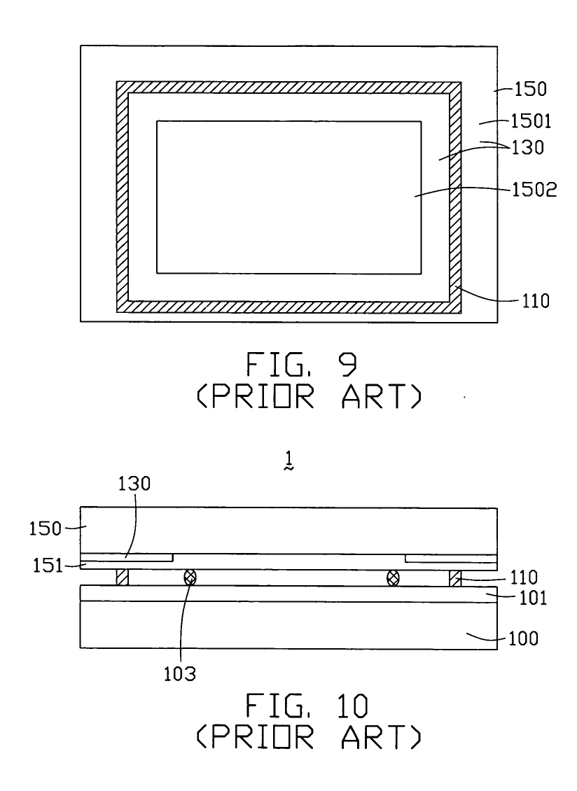

FIGS. 7 and 8 are schematic, cross-sectional views of sequential stages in a method for manufacturing the liquid crystal display panel 4.

Referring to FIG. 7, the first substrate 400 and the second substrate 450 are provided. The second substrate 450 includes the peripheral area 4501 and the display area 4502. The black matrix 430 is formed on the region straddling the peripheral area 4501 and the display area 4502. The alignment film 451 is formed on the second substrate 450, and covers the black matrix 430. The alignment film 401 is formed on the first substrate 400.

Referring to FIG. 8, liquid crystal molecules 403 are dropped onto the alignment film 401. The sealant 410 is formed on the alignment film 451 in the peripheral area 4501. The sealant 410 and the black matrix 430 are spaced apart by a horizontal gap, so that light can pass through the second substrate 450 and harden the sealant 410. The blocker 460 is formed on the alignment film 451. The blocker 460 is deposited between the sealant 410 and the display area 4502, so that it can separate the sealant 410 and the liquid crystal molecules 403. The optical spacer 470 is formed on the alignment film 451 in a position corresponding to beyond the outside extremity of the black matrix 430.

Referring to FIG. 6, the second substrate 450 is turned over and positioned on the first substrate 400. Assembly of the first substrate 400 and the second substrate 450 is performed in a vacuum chamber (not shown). After that, the combined substrates 400, 450 are taken out from the vacuum chamber. The substrates 400, 450 are securely held together by reason of atmospheric pressure exerting on the combination. Then the sealant 410 is hardened by UV radiation, so that the substrates 400, 450 are firmly attached together. The liquid crystal display panel 4 is thus formed.

Many modifications and variations are possible within the ambit of the invention herein. For example, the blocker and the sealant may be connected together. The blocker, the sealant and the optical spacer may be formed on the first substrate instead of the second substrate. The black matrix may be made from chromium oxide (CrOx).

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

1. A liquid crystal display panel comprising:
a first substrate and a second substrate opposite to each other, said second substrate defining a display area and a peripheral area;
a liquid crystal layer containing a plurality of liquid crystal molecules disposed between said first and second substrates;
a sealant associated with said peripheral area for supporting and adhering said first and second substrates together; and
an isolating member isolating said sealant from said liquid crystal layer.

2. The liquid crystal display panel as claimed in claim 1, wherein said isolating member is made of elastic material.

3. The liquid crystal display panel as claimed in claim 1, wherein said sealant and said isolating member are each in the form of a continuous line.

4. The liquid crystal display panel as claimed in claim 1, wherein said sealant and said isolating member are spaced apart by a substantially uniform gap.

5. The liquid crystal display panel as claimed in claim 1, further comprising a black matrix provided on said second substrate.

6. The liquid crystal display panel as claimed in claim 5, wherein said black matrix and said sealant are spaced apart a substantially uniform distance.

7. The liquid crystal display panel as claimed in claim 6, further comprising an optical spacer positioned at an outside of said black matrix.

8. A liquid crystal display panel comprising:
a first substrate and a second substrate opposite to each other, said second substrate defining a display area and a peripheral area;
a liquid crystal layer containing a plurality of liquid crystal molecules disposed between said first and second substrates;
a sealant formed at said peripheral area for supporting and adhering said first and second substrates together; and
a blocker formed on said peripheral area for isolating said liquid crystal layer from said sealant.

9. The liquid crystal display panel as claimed in claim 8, wherein said blocker is made of elastic material.

10. The liquid crystal display panel as claimed in claim 8, wherein said sealant and said blocker are each in the form of a continuous line.

11. The liquid crystal display panel as claimed in claim 8, wherein said sealant and said blocker are spaced apart by a substantially uniform gap.

12. The liquid crystal display panel as claimed in claim 8, further comprising a black matrix provided on said second substrate.

13. The liquid crystal display panel as claimed in claim 12, wherein said black matrix and said sealant are spaced apart a substantially uniform distance.

14. The liquid crystal display panel as claimed in claim 13, further comprising an optical spacer associated with a periphery of said black matrix.

15. A method for manufacturing a liquid crystal display panel, comprising:
providing a first substrate and a second substrate, said second substrate defining a display area and a peripheral area;
forming a sealant associated with said peripheral area of said second substrate;
forming an isolating member associated with said peripheral area of said second substrate, said isolating member being associated with said sealant;
dropping liquid crystal material on said first substrate;
attaching and integrating said first substrate and said second substrate together in a vacuum chamber; and
hardening said sealant using ultraviolet light.

16. The method for manufacturing a liquid crystal display panel according to claim 15, wherein said sealant and said isolating member are spaced apart by a substantially uniform gap.

17. The method for manufacturing a liquid crystal display panel according to claim 15, further comprising forming a black matrix associated with said second substrate.

18. The method for manufacturing a liquid crystal display panel according to claim 17, further comprising forming an optical spacer associated with a periphery of said black matrix.

19. The liquid crystal display panel as claimed in claim 1, wherein an isolating member fully circumferentially surrounds said liquid crystal layer.

20. The liquid crystal display panel as claimed in claim 8, wherein said blocker fully circumferentially surrounds said liquid crystal layer.
